(19) United States
(12) Patent Application Publication
(10) Pub. No.: US 2008/0066747 A1
(43) Pub. Date: Mar. 20, 2008

(54) Nebulizer mouthpiece support stand

(76) Inventor: DeAnn Spink, Longwood, NC (US)

Correspondence Address: P. Jeff Martin of The McGougan Law Firm, LLC;Suite 200, 2120 Sea Mountain Hwy.,, P.O. Box 4369, N. Myrtle Beach, SC, 29597, US

(21) Appl. No.: 11/786,912

(22) Filed: Apr. 13, 2007

Related U.S. Application Data
(60) Provisional application No. 60/845,190, filed on Sep. 18, 2006.

(51) Int. Cl. B32B 3/04; A62B 7/00

(52) U.S. Cl. 128/202.13; 428/127

(57) ABSTRACT

A portable stand for supporting or holding a nebulizer mouthpiece.

### RELATED APPLICATIONS

This application claims the benefit of U.S. Provisional Application No. 60/845,190 filed on Sep. 18, 2006.

### BACKGROUND OF THE INVENTION

1. Field of the Invention

The present invention relates generally to holders or stands and, more particularly, to a portable nebulizer mouthpiece stand.

2. Description of the Related Art

Medical nebulizers that nebulize a fluid into an aerosol for inhalation by a patient are commonly utilized for the treatment of certain conditions and diseases such as cystic fibrosis, asthma, chronic obstructive pulmonary disease and other respiratory diseases. Nebulizers entrain medication or moisture in a stream of air or oxygen to produce a mist which is breathed in by the patient under ambient pressure conditions.

Nebulizer devices in general are not very portable. However, nebulizers include a disposable nebulizer inhalation mouthpiece portion which has a relatively small size and is therefore easily portable. After use, these nebulizer inhalation mouthpieces are placed or laid indiscriminately atop any proximally-located surface.

Accordingly, a need has arisen for a portable, nebulizer mouthpiece stand adapted to support a nebulizer mouthpiece in a manner which is quick, easy, and efficient. The development of the portable nebulizer mouthpiece support device fulfills this need.

### SUMMARY OF THE INVENTION

Therefore, it is an object of the present invention to provide a portable, nebulizer mouthpiece stand adapted to support a nebulizer mouthpiece.

It is another object of the present invention to provide a nebulizer mouthpiece stand which includes a plurality of cutouts for accommodating a carrier gas inlet tube and a fluid channel tube or air outlet of a nebulizer output component.

It is another object of the present invention to provide a nebulizer mouthpiece stand having a base with a non-skid bottom surface.

It is another object of the present invention to provide a nebulizer mouthpiece stand constructed of a lightweight, rigid material.

Briefly described according to one embodiment of the present invention, a portable nebulizer mouthpiece support device is disclosed. The device comprises a housing having a solid base from which an upstanding, elongated tubular body extends integrally therefrom. The base defines a circular shape having a non-skid bottom surface. The tubular body defines a cylindrical body wall having an open upper end extending into a hollow interior. The tubular body is sizably adapted to slidably receive the nebulization chamber of a nebulizer output component, such as a nebulizer mouthpiece or nebulizer mask, in a snug-fit manner.

The housing includes a plurality of cutouts or openings suited to receive a carrier gas inlet tube and an anterior end of a fluid channel tube or air outlet of a nebulizer output component operable for use with a nebulizer unit. The first cutout is formed along an upper edge of body wall by opposing L-shaped recesses between which a generally square or rectangularly-shaped, enlarged slot is formed. The enlarged slot has a linearly-elongated, narrow slot extending directly downward therefrom. The enlarged slot is sizably adapted to snugly accommodate the anterior end of the fluid channel tube or air outlet of a nebulizer output component.

The second cutout is formed along an upper edge of body wall positioned opposed to first cutout. The second cutout is defined as having a generally square or rectangular shape. The second cutout is sizably adapted to snugly accommodate a posterior end of the fluid channel tube onto the wall of the body.

The use of the present invention allows for a nebulizer mouthpiece or nebulizer mask to be snugly supported within a stand in a manner which is quick, easy, and efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a nebulizer mouthpiece stand, according to the preferred embodiment of the present invention;

FIG. 2 is a front side elevational view thereof;

FIG. 3 is a rear side elevational view thereof;

FIG. 4 is a top side view thereof;

FIG. 5 is a cross-sectional view of the present invention illustrating the hollow interior thereof;

FIG. 6 is a perspective view of the nebulizer mouthpiece shown connected to a nebulizer unit;

FIG. 7 is a perspective view of the nebulizer mask shown connected to a nebulizer unit;

FIG. 8 is a perspective view of the nebulizer mouthpiece;

FIG. 9 is a perspective view of the nebulizer mask;

FIG. 10 is a perspective view of the present invention shown supporting a nebulizer mouthpiece, according to the preferred embodiment; and

FIG. 11 is a perspective view of the present invention shown supporting a nebulizer mask, according to the preferred embodiment.

### DESCRIPTION OF THE PREFERRED EMBODIMENT

### 1. Detailed Description of the Figures

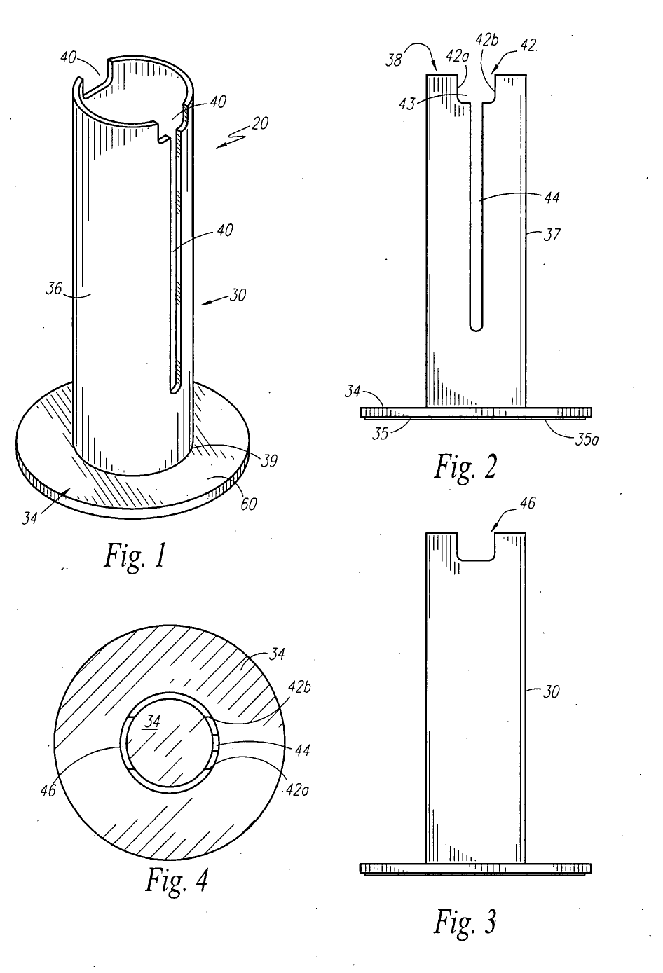

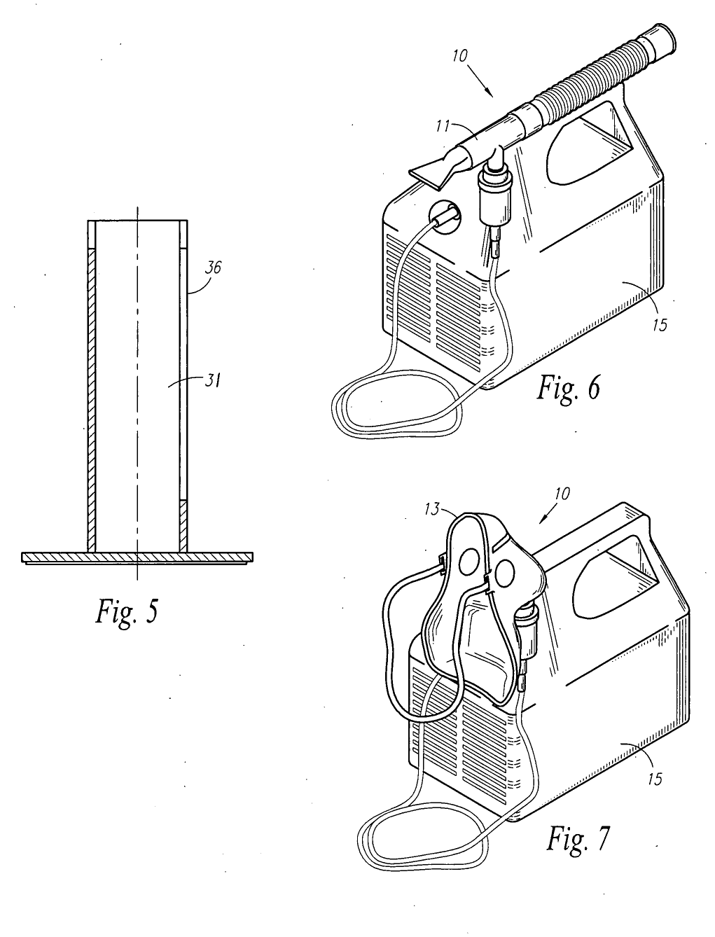

Referring now to FIGS. 1-5, a portable nebulizer mouthpiece support device 20 is shown, according to the present invention, comprised of a housing 30 having a solid base 34 from which an upstanding, elongated tubular body 36 extends integrally therefrom. Tubular body 36 defines a diameter measuring less than a diameter defining solid base 34. The tubular body 36 is integrally connected to base 34 at an interface 39 from which base 34 extends radially so as to form an apron 60. The tubular body 36 defines a cylindrical body wall 37 having an open upper end 38 extending into a hollow interior 31 which provides direct passage to the base 34. The open upper end 38 of tubular body 36 is sizably adapted to slidably receive the nebulization chamber 50 of a nebulizer output component 10 in a snug-fit manner. The open upper end 38 of tubular body 36 defines a diameter measuring slightly larger than a diametric measure of nebulization chamber 50. The open upper end 38 of tubular body 36 provides direct passage to the hollow interior 31 of tubular body 36 within which nebulization chamber 50 is slidably received in a snug-fit manner.

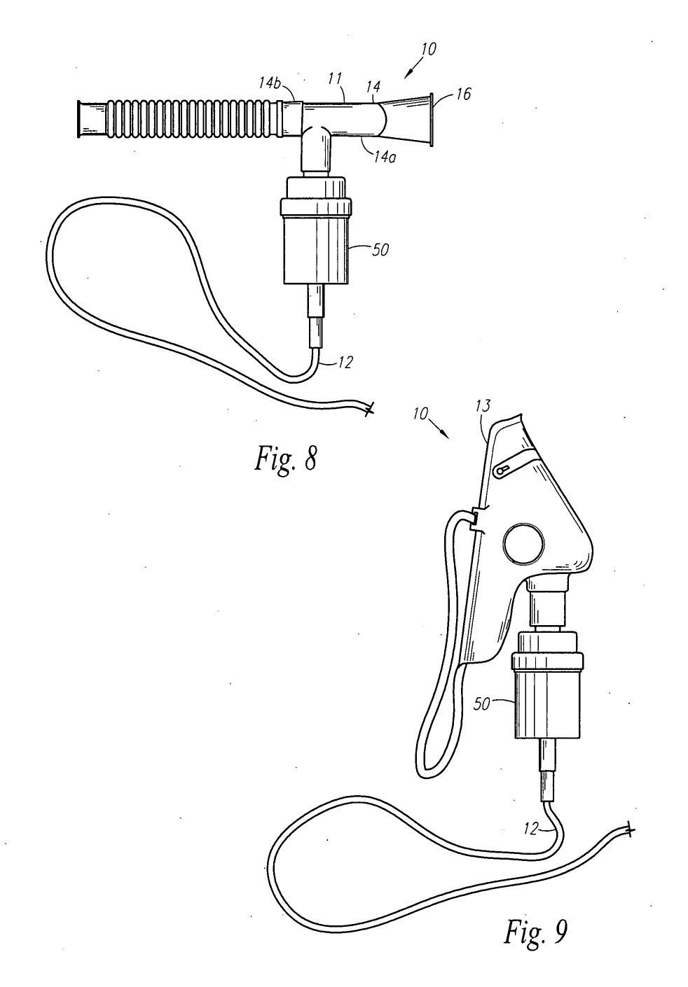

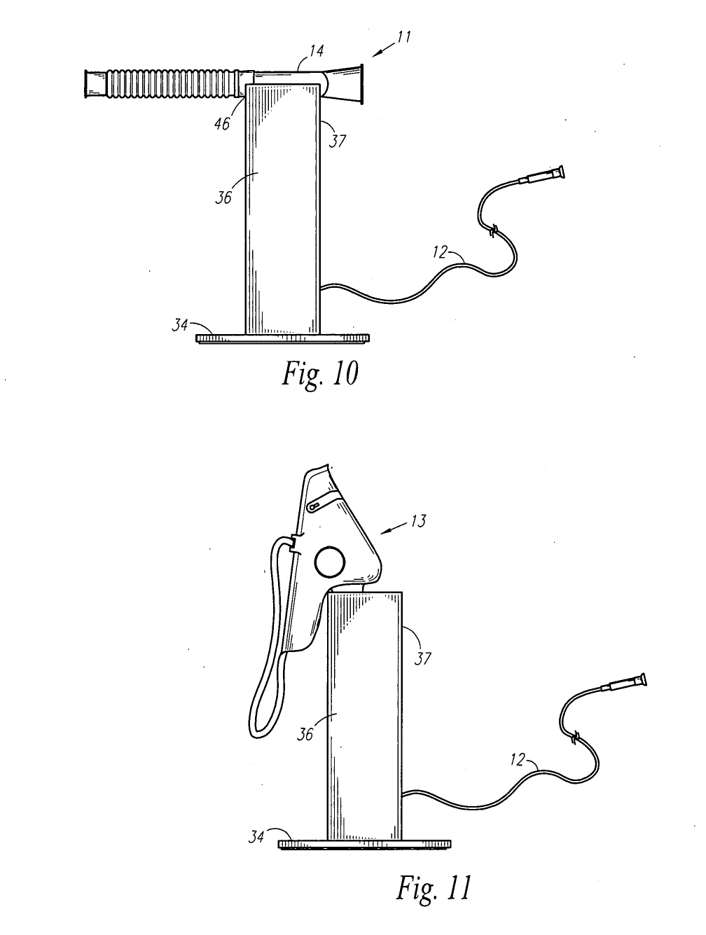

The housing 30 includes a plurality of cutouts 40 or openings suited to receive a carrier gas inlet tube 12 and an anterior end 14a of a fluid channel tube 14 or air outlet 16 of a nebulizer output component 10 operable for use with a nebulizer unit 15. The nebulizer output component 10 is available in the form of a mouthpiece 11 and mask 13, as shown in FIG. 8 and FIG. 9, respectively. The mouthpiece 11 is shown connected to a nebulizer unit 15 in FIG. 6. The mask 13 is shown connected to a nebulizer unit 15 in FIG. 7. More specifically, portions of the body wall 37 of tubular body 36 are cutout 40 in order to snugly accommodate the carrier gas inlet tube 12 and the anterior end 14a of the fluid channel tube 14 of mouthpiece 11 onto the wall 37 of the body 36 as shown in FIG. 10.

The first cutout 42 is formed along an upper edge of body wall 37 by opposing L-shaped recesses 42a, 42b between which a generally square or rectangularly-shaped, enlarged slot 43 is formed. Enlarged slot 43 has a linearly-elongated, narrow slot 44 extending directly downward centrally therefrom. The enlarged slot 43 is sizably adapted to snugly accommodate the fluid channel tube 14 or air outlet 16 of a nebulizer output component 10, such as the mouthpiece 11. The narrow slot 44 is sizably adapted to snugly accommodate the carrier gas inlet tube 12 of a nebulizer output component 10, such as the mouthpiece 11.

The second cutout 46 is formed along an upper edge of body wall 37 positioned opposed to first cutout 42. Second cutout 46 is defined as having a generally square or rectangular shape. The second cutout 46 is sizably adapted to snugly accommodate a posterior end 14b of the fluid channel tube 14 onto the wall 37 of the body 36 as shown in FIG. 10.

Referring now to FIGS. 1-5, and 11, the open upper end 38 of tubular body 36 is sizably adapted to slidably receive the nebulization chamber 50 of mask 13 in a snug-fit manner. The open upper end 38 of tubular body 36 defines a diameter measuring slightly larger than a diametric measure of nebulization chamber 50. The open upper end 38 of tubular body 36 provides direct passage to the hollow interior 31 of tubular body 36 within which nebulization chamber 50 is slidably received in a snug-fit manner. The carrier gas inlet tube 12, shown extending downward from the nebulization chamber 50 of mask 13 in FIG. 9, is snugly received and supported within the narrow slot 44 of body wall 37. Thus, narrow slot 44 is sizably adapted to snugly accommodate the carrier gas inlet tube 12 of a nebulizer mask 13.

The housing 30 is fabricated of a lightweight, rigid material such as plastic or a plastic polymer.

The base 34 defines a circular shape having a non-skid bottom surface 35. The non-skid bottom surface 35 is comprised of a thin layer or membrane of non-skid material 35a suitably affixed to an underside of base 34. The thin layer or membrane of non-skid material 35a defines a diameter measuring substantially equal to a diameter defining base 34.

The base 34 is further defined as having a diameter being of sufficient size and measure to support the present invention and nebulizer output component 10 in an upright, stable manner without tilting or toppling over.

### 2. Operation of the Preferred Embodiment

To use the present invention, user places the bottom end of the base 34 of the nebulizer mouthpiece support device 20 atop a flat surface. User next inserts the nebulization chamber 50 of a nebulizer mouthpiece 11 inside the hollow interior 31 of tubular body 36, positions the carrier gas inlet tube 12 within narrow slot 44, positions the anterior end 14a of the fluid channel tube 14 of the mouthpiece 11 within enlarged slot 43, and positions the posterior end 14b of the fluid channel tube 14 within second cutout 46.

The use of the present invention allows for a nebulizer mouthpiece 11 or nebulizer mask 13 to be snugly supported within a stand in a manner which is quick, easy, and efficient.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. A nebulizer mouthpiece support device comprising:
a housing, said housing having a solid base from which an upstanding, elongated tubular body extends integrally therefrom, said housing having a plurality of cutouts defined therein.

2. The nebulizer mouthpiece support device of claim 1, wherein said tubular body defines a diameter measuring less than a diameter defining said base.

3. The nebulizer mouthpiece support device of claim 1, wherein said tubular body defines a cylindrical body wall having an open upper end extending into a hollow interior, wherein said hollow interior provides direct passage to said base.

4. The nebulizer mouthpiece support device of claim 1, wherein said tubular body is integrally connected to said base at an interface, said base extends radially from said interface so as to form an apron.

5. The nebulizer mouthpiece support device of claim 1, wherein said tubular body is sizably adapted to slidably receive a nebulization chamber of a nebulizer output component in a snug-fit manner.

6. The nebulizer mouthpiece support device of claim 1, wherein said plurality of cutouts includes a cutout sizably adapted to receive a carrier gas inlet tube of a nebulizer output component.

7. The nebulizer mouthpiece support device of claim 1, wherein said plurality of cutouts is sizably adapted to receive a carrier gas inlet tube and an anterior end of a fluid channel tube or an air outlet of a nebulizer output component.

8. The nebulizer mouthpiece support device of claim 1, wherein said plurality of cutouts includes a first cutout formed along an upper edge of said body wall by opposing L-shaped recesses, said opposing L-shaped recesses having a generally square-shaped or rectangularly-shaped, enlarged slot formed there between.

9. The nebulizer mouthpiece support device of claim 8, wherein said enlarged slot has a linearly-elongated, narrow slot extending directly downward centrally therefrom.

10. The nebulizer mouthpiece support device of claim 9, wherein said enlarged slot is sizably adapted to snugly accommodate the fluid channel tube or the air outlet of the nebulizer output component.

11. The nebulizer mouthpiece support device of claim 9, wherein said narrow slot is sizably adapted to snugly accommodate the carrier gas inlet tube of the nebulizer output component.

12. The nebulizer mouthpiece support device of claim 1, wherein said plurality of cutouts includes second cutout formed along the upper edge of said body wall, said second cutout is positioned opposed to said first cutout, said second cutout is defined as having a generally square or rectangular shape, said second cutout is sizably adapted to snugly accommodate a posterior end of the fluid channel tube of the nebulizer output component onto said body wall of said tubular body.

13. The nebulizer mouthpiece support device of claim 1, wherein said housing is fabricated of a lightweight, rigid material.

14. The nebulizer mouthpiece support device of claim 1, wherein said base defines a circular shape.

15. The nebulizer mouthpiece support device of claim 5, wherein the nebulizer output component includes a nebulizer mouthpiece and a nebulizer mask.

16. The nebulizer mouthpiece support device of claim 10, wherein the nebulizer output component is a nebulizer mouthpiece.

17. The nebulizer mouthpiece support device of claim 11, wherein the nebulizer output component is a nebulizer mouthpiece.

18. The nebulizer mouthpiece support device of claim 11, wherein the nebulizer output component is a nebulizer mask.

19. The nebulizer mouthpiece support device of claim 12, wherein the nebulizer output component is a nebulizer mouthpiece.

20. The nebulizer mouthpiece support device of claim 1, wherein said base has a non-skid bottom surface.
